(19) United States
(12) Patent Application Publication
(10) Pub. No.: US 2007/0030420 A1
(43) Pub. Date: Feb. 8, 2007

(54) Liquid crystal display and method of assembling the same

(75) Inventor: Yang-gyu Jang, Chungcheongnam-do (KR)

Correspondence Address: F. Chau & Associates, LLC, 130 Woodbury Road, Woodbury, NY, 11797, US

(73) Assignee: Samsung Electronics Co., Ltd.

(21) Appl. No.: 11/500,238

(22) Filed: Aug. 7, 2006

(30) Foreign Application Priority Data
Aug. 8, 2005 (KR) 10-2005-0072428

(51) Int. Cl. G02F 1/1335

(52) U.S. Cl. 349/96

(57) ABSTRACT

A liquid crystal display (LCD) includes a liquid crystal panel having a first substrate, a second substrate, and a liquid crystal layer interposed therebetween, a polarizing film formed on at least one surface of the liquid crystal panel, and a conductive medium formed on at least a part of the polarizing film on the liquid crystal panel

This application claims priority from Korean Patent Application No. 10-2005-0072428 filed on Aug. 8, 2005, the disclosure of which is hereby incorporated by reference herein in its entirety.

### BACKGROUND OF THE INVENTION

1. Technical Field

The present disclosure relates to a liquid crystal display (LCD) capable of preventing a polarizing film from being deformed and a method of assembling the same.

2. Description of the Related Art

A liquid crystal display (“LCD”), is a widely used flat panel display, which may include, for example, two substrates having a plurality of electrodes with a liquid crystal layer interposed therebetween. In addition, an LCD may display an image by forming an electric field by applying different voltages to a pixel electrode and a reference electrode to change the arrangement of liquid crystal molecules in the liquid crystal layer, to thereby adjust the amount of light transmitted therethrough.

Moreover, there are a variety of different types of LCDs. For example, a patterned vertically aligned (PVA) mode for an LCD in which a cutting pattern is formed in a pixel electrode and a reference electrode, respectively, uses a vertical alignment (VA) technology which may be substituted for an in plane switching (IPS) mode when designing an LCD.

In the IPS mode, as a reference electrode formed on an upper substrate is in the shape of a plate, the generation of static electricity may be avoided by applying an external pressure to a liquid crystal panel. On the other hand, in the PVA mode, as a reference electrode formed on an upper substrate has a cutting pattern, charges are accumulated on the cutting pattern portion when an external pressure is applied to a liquid crystal panel, thereby possibly resulting in reduced movement of the charges, which in turn may cause the generation of static electricity.

Therefore, to prevent static electricity generated by applying an external pressure to the liquid crystal panel, a new PVA mode polarizing film construction has been designed, in which a conductive film is added to the polarizing film.

In the above-mentioned polarizing film construction, upper and lower supporting films are attached to upper and lower surfaces of a polymer polarizing film, an upper protective film is adhered to the upper supporting film, and an adhesive film and a lower protective film are adhered to the lower supporting film. Moreover, to avoid display damage to the LCD caused by static electricity, an antistatic layer is further provided on the upper supporting film.

However, there still may be certain difficulties associated with the above conventional polarizing film construction in connection with charge accumulation. Namely, in the above conventional polarizing film construction, the polarizing film is attached to a central portion of a liquid crystal panel and is formed at a predetermined distance from a top chassis made of stainless steel, for preventing a surface of the polarizing film from being split caused by an external pressure (e.g. a vibration) being applied thereto. Thus, when external charges are induced to the polarizing film, the polarizing film is brought into contact with the liquid crystal panel which is an insulator and the charges thus may not escape. Eventually, the charges accumulate on the polarizing film, which causes a voltage difference between upper and lower substrates of the liquid crystal panel, thereby deteriorating the display quality of the LCD.

In addition, the above-mentioned conventional polarizing film is a polymer polarizing film which is also susceptible to deformation due to moisture. Thus, when the polarizing film is attached to the liquid crystal panel, moisture may permeate into lateral surfaces of the polarizing film causing the polymer polarizing film to shrink, thereby deteriorating the liquid crystal panel of the LCD.

Thus, there is a need for a liquid crystal display (LCD) capable of preventing a polarizing film from being deformed and a method of forming the same.

### SUMMARY OF THE INVENTION

The exemplary embodiments of the present invention provide a liquid crystal display (LCD) capable of preventing a polarizing film from being deformed.

The exemplary embodiments of the present invention also provide a method of assembling an LCD capable of preventing a polarizing film from being deformed.

According to an exemplary embodiment of the present invention, a liquid crystal display (LCD) is provided. The LCD includes a liquid crystal panel having a first substrate and a second substrate formed by interposing a liquid crystal layer on the first substrate, a polarizing film formed on at least one surface of the liquid crystal panel, and a conductive medium formed on at least a part of the polarizing film on the liquid crystal panel.

According to another exemplary embodiment of the present invention, a method of assembling a liquid crystal display (LCD) is provided. The method includes providing a liquid crystal panel having a first substrate and a second substrate formed by interposing a liquid crystal layer on the first substrate, attaching a polarizing film onto at least one surface of the liquid crystal panel, and forming a conductive medium on at least a part of the polarizing film on the liquid crystal panel using a conductive medium.

### BRIEF DESCRIPTION OF THE DRAWINGS

Exemplary Embodiments of the present invention can be understood in more detail from the following description taken in conjunction with reference to the attached drawings in which:

FIG. 1 is a schematic exploded perspective view of a liquid crystal display (LCD) according to an exemplary embodiment of the present invention;

FIG. 2 is a cross-sectional view of the LCD shown in FIG. 1;

FIG. 3 is a cross-sectional view of an LCD according to an exemplary embodiment of the present invention;

FIG. 4 illustrates a charge-moving path generated by forming a conductive medium of the LCD shown in FIG. 3;

FIG. 5 is a flowchart illustrating a method of assembling an LCD according to an exemplary embodiment of the present invention; and

FIGS. 6 through 11 illustrate various assembling operations in the method of assembling the LCD shown in FIG. 5.

### DETAILED DESCRIPTION OF EXEMPLARY EMBODIMENTS

The present invention may be embodied in many different forms and should not be construed as being limited to the exemplary embodiments set forth herein. Like reference numerals refer to like elements throughout the specification.

Hereinafter, the exemplary embodiments of the present invention are described with reference to the accompanying drawings.

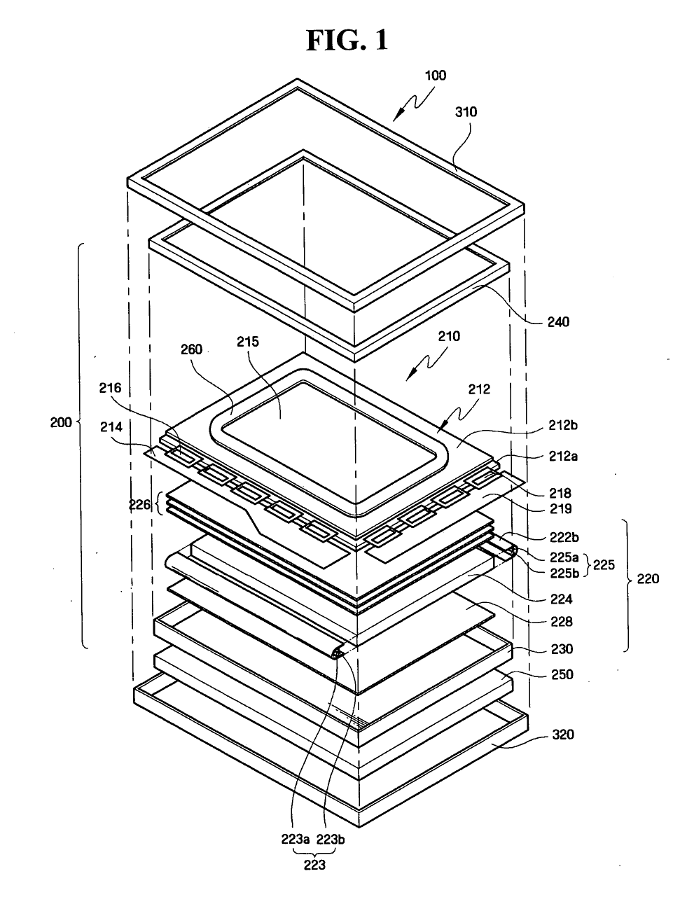

FIG. 1 is a schematic exploded perspective view of a liquid crystal display (LCD) according to an exemplary embodiment of the present invention.

Referring to FIG. 1, a liquid crystal display (LCD) 100 according to an exemplary embodiment of the present invention includes a liquid crystal display module 200 that displays a picture in response to an applied image signal, a front case 310 that receives the liquid crystal display module 200, and a rear case 320. The liquid crystal display module 200 includes a display unit 210 including a liquid crystal panel 212 that displays a picture.

The display unit 210 includes the liquid crystal panel 212, a data printed circuit board (PCB) 214, a gate PCB 219, a data tape carrier package (TCP) 216, and a gate-side TCP 218.

The liquid crystal panel 212 that includes a thin film transistor substrate 212a, a color filter substrate 212b and liquid crystal molecules displays an image.

For example, the thin film transistor substrate 212a may be a transparent glass substrate on which thin film transistors are formed in a matrix array. Data lines are connected to source terminals of the thin film transistors and gate lines are connected to gate terminals thereof. In addition, pixel electrodes made of, for example, indium tin oxide (ITO), which is a transparent conductive material, are formed in drain terminals of the thin film transistors.

An electrical signal is applied to a source and a gate terminal of each of the thin film transistors through data and gate lines. The thin film transistors switch on or off in response to the electrical signal. Then, electrical signals for forming pixels are output to the drain terminals of the thin film transistors.

The color filter substrate 212b is provided to face the thin film transistor substrate 212a. The color filter substrate 212b is formed by a thin film formation process in which red (R), green (G), and blue (B) color pixels are produced while light passes through the same. The color filter substrate 212b is also provided with a common electrode made of, for example, ITO.

When power is applied to the gate and source terminals of the thin film transistor of the above-described thin film transistor substrate 212a and the thin film transistor is turned on, an electric field is formed between the pixel electrode and the common electrode of the color filter substrate 212b. The electric field is utilized to change the arrangement angle of liquid crystal molecules interposed between the thin film transistor substrate 212a and the color filter substrate 212b. By changing the arrangement angle of the liquid crystal molecules, the optical transmittance of the LCD 100 may also be controlled which in turn may produce a desired image.

Polarizing films 215 are disposed on top and bottom surfaces of the liquid crystal panel 212, respectively. The polarizing films 215 transmit only light emitted from a backlight unit 220 of the LCD 100 that vibrates in the same direction as a polarization axis and absorbs or reflects light that vibrates in the remaining directions to form light that vibrates in a predetermined direction. Here, the polarizing films 215 may be made of, for example, a material selected from polyvinyl alcohol, polycarbonate, polystyene and polymetacrylate. For example, the polarizing films 215 can be obtained by stretching a polyvinyl alcohol film, soaking the polyvinyl alcohol film into iodine (I₂) and dichroic dye solution and arranging an I₂ molecule and a dye molecule to be parallel to each other in the stretched direction. At this time, as the (I₂) molecule and the dye are dichroic molecules, light that vibrates in the stretched direction is absorbed, and light that vibrates in a vertical direction is transmitted.

A conductive medium or a conductive guard ring 260 surrounds edges and lateral surfaces of the polarizing films 215 and contacts a portion of a top chassis 240. The conductive medium 260 protects the polarizing films 215 from external moisture and prevents the polarizing films 215 from being shrunk. In addition, the conductive medium 260 serves as ground so that charges accumulated on the polarizing films 215 can be discharged to the outside of the liquid crystal panel 212 through the top chassis 240 and thus damage to the liquid crystal panel 212 which may be caused by static electricity may be prevented.

To control the arrangement angle of the liquid crystal molecules of the liquid crystal panel 212, a driving signal and a timing signal are applied to the gate line and the data line of the thin film transistor. As shown in FIG. 1, the data TCP 216 which is a kind of a flexible circuit board (FCB) for determining the time for applying a data driving signal is attached to a source of the liquid crystal panel 212. Additionally, the gate TCP 218 which is a kind of an FCB for determining the time for applying a gate driving signal is attached to a gate of the liquid crystal panel 212.

The data PCB 214 and the gate PCB 219 which each apply a driving signal to each of a gate line and a data line in response to an image signal applied from the outside of the liquid crystal panel 212 are connected to each of the data TCP 216 of the liquid crystal panel 212 and the gate TCP 218 of the gate line.

A source unit for supplying a data driving signal to the liquid crystal panel 212 in response to the image signal generated from an external information processing apparatus such as a computer is formed on the data PCB 214, and a gate unit for supplying a gate driving signal to the gate line of the liquid crystal panel 212 is formed in the gate PCB 219.

That is, the data PCB 214 and the gate PCB 219 generate a gate driving signal and a data signal for driving the LCD 100. Moreover, a plurality of timing signals for applying the signals at a particular time, apply the gate driving signal to the gate line of the liquid crystal panel 212 through the gate TCP 218 and the data signal to the data line of the liquid crystal panel 212 through the data TCP 216.

The backlight unit 220 for providing uniform light to the display unit 210 is disposed below the display unit 210. The backlight unit 220 includes first and second lamp units 223 and 225 that are disposed at both ends of the liquid crystal display module 200 and generate light. The first and second lamp units 223 and 225 include first and second lamps 223a and 223b and third and fourth lamps 225a and 225b and are protected by first and second lamp covers 222a and 222b.

A light guide plate 224 is disposed below the liquid crystal panel 212 having a size corresponding to the liquid crystal panel 212 of the display unit 210. The light guide plate 224 guides light generated in the first and second lamp units 223 and 225 toward the display unit 210 and changes the path of light.

The light guide plate 224 is an edge shaped plate having a uniform thickness, and the first and second lamp units 223 and 225 are installed at both ends of the light guide plate 224 so as to improve the light efficiency of the LCD 100. The number of lamps of the first and second lamp units 223 and 225 may be varied based upon the size of the LCD 100.

A plurality of optical sheets 226 are disposed on the light guide plate 224. The plurality of optical sheets 226 maintain at a uniform level the brightness of the light which is emitted from the light guide plate 224 and directed to the liquid crystal panel 212. In addition, a reflection plate 228 is disposed below the light guide plate 224. The reflection plate 228 reflects light leaked from the light guide plate 224 toward the light guide plate 224, to improve the light efficiency of the LCD 100.

The display unit 210 and the backlight unit 220 are fixedly supported by a mold frame 230 that is a receiving container. The mold frame 230 has a rectangular box shape and a top surface thereof is opened.

A bottom chassis 250 is connected to a bottom surface of the mold frame 230, and the top chassis 240 is connected to an upper portion of the mold frame 230 so that edges of the liquid crystal panel 212 and lateral surfaces of the mold frame 230 are surrounded. At this time, the top chassis 240 is connected to an upper portion of the backlight unit 220 to fix the liquid crystal panel 212, and an opening for exposing the liquid crystal panel 210 is formed in the top chassis 240.

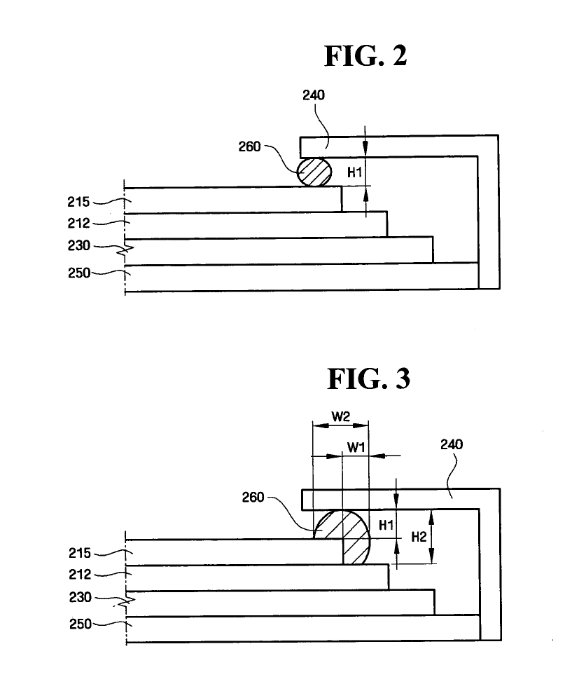

FIG. 2 is a cross-sectional view of the LCD shown in FIG. 1.

Referring to FIG. 2, the mold frame 230, the liquid crystal panel 212, and the polarizing film 215 are sequentially formed over the bottom chassis 250. In addition, the top chassis 240 contacts a portion of the bottom chassis 250, and an opening for exposing the active region of the liquid crystal panel 212 is formed in the top chassis 240. The conductive medium 260 is formed along the edges of the polarizing film 215 and contacts a portion of the top chassis 240. Here, the conductive medium 260 is preferably made of a silicon-based material and may further include, for example, conductive particles in addition to the silicon-based material. The conductive particles may be made of, for example, one material selected from the group consisting of silver (Ag), ceramics, nickel (Ni), copper (Cu), and aluminum (Al). The conductive medium 260 has a predetermined depth H1 from the top surface of the polarizing film 215 so that it sufficiently contacts the top chassis 240 when attaching the top chassis 240. Thus, the conductive medium 260 may have a height H1 in a range of about 0.20 to about 0.30 millimeters (mm) from the top surface of the polarizing film 215.

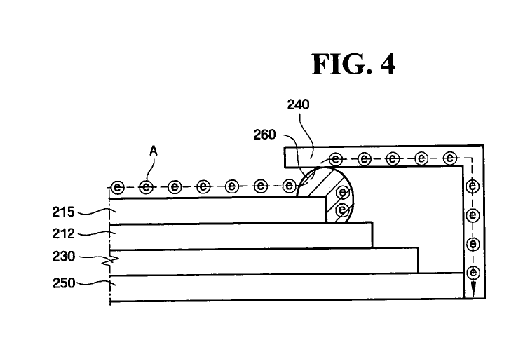

FIG. 3 is a cross-sectional view of an LCD according to an exemplary embodiment of the present invention, and FIG. 4 illustrates a charge-moving path generated by forming a conductive medium of the LCD shown in FIG. 3.

Referring to FIG. 3, the mold frame 230, the liquid crystal panel 212, and the polarizing film 215 are sequentially formed over the bottom chassis 250. In addition, the top chassis 240 contacts a portion of the bottom chassis 250, and an opening for exposing the active region of the liquid crystal panel 212 is formed in the top chassis 240. The conductive medium 260 surrounds edges and lateral surfaces of the polarizing film 215 and contacts a portion of the top chassis 240. Here, for example, the conductive medium 260 may be made of a silicon-based material, and may further include conductive particles in addition to the silicon-based material. The conductive particles may be made of, for example, one material selected from the group consisting of silver, ceramics, nickel, copper, and aluminum. The conductive medium 260 has a predetermined depth H1 from the top surfaces of the polarizing film 215 and the liquid crystal panel 212 so that it sufficiently contacts the top chassis 240 when attaching the top chassis 240. Thus, the conductive medium 260 may have a height H1 in a range of about 0.20 to about 0.30 mm from the top surface of the polarizing film 215 and may have a height H2 in a range of about 0.45 to about 0.55 mm from the top surface of the liquid crystal panel 212. In addition, the conductive medium 260 has a predetermined width W1 from the lateral surfaces of the polarizing film 215. In this case, the conductive medium 260 has a width W1 of about 1.2 to about 1.4 mm from the lateral surfaces of the polarizing film 215, and the conductive guide ring 260 formed over the polarizing film 215 and the liquid crystal panel 212 has a width W2 of about 1.5 to about 2.5 mm.

Referring to FIG. 4, the conductive medium 260 surrounds the edges and lateral surfaces of the polarizing film 215 and contacts a portion of the top chassis 240. Since the conductive medium 260 includes conductive particles, it serves as ground so that charges accumulated on the polarizing film 215 may be discharged to the outside of the liquid crystal panel 212 through the top chassis 240, thereby preventing picture abnormality of the liquid crystal panel 212 which may be caused by static electricity.

In addition, as the conductive medium 260 surrounds the lateral surfaces of the polarizing film 215, it protects the polarizing film 215 from external moisture and prevents moisture from permeating into the polarizing film 215 under humid conditions, thereby also preventing the polarizing film 215 from shrinking.

A method of assembling the LCD 100 will now be described.

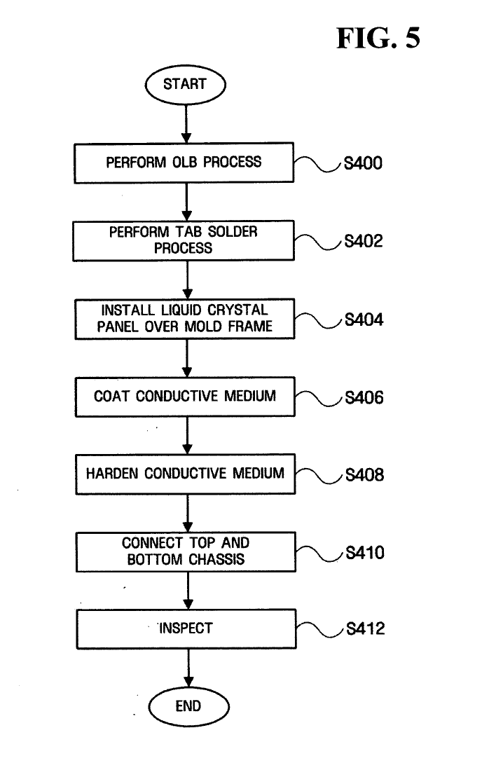

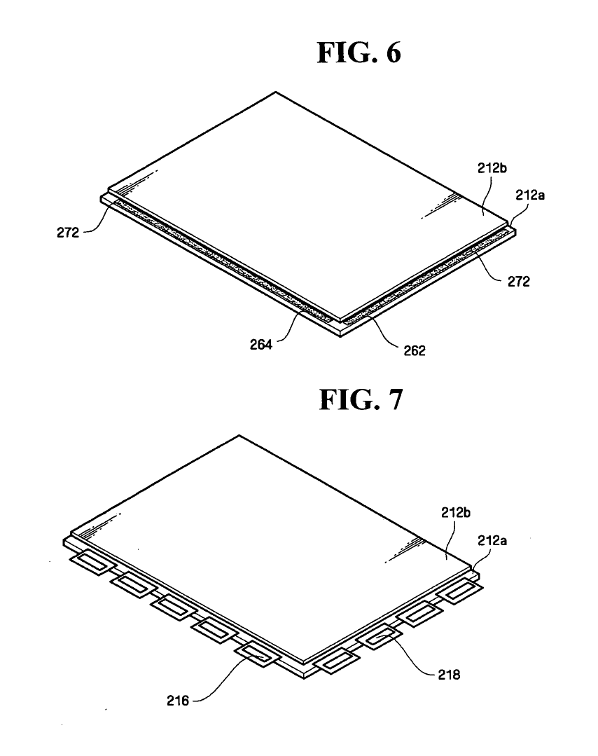

FIG. 5 is a flowchart illustrating a method of assembling an LCD according to an exemplary embodiment of the present invention, and FIGS. 6 through 11 illustrate various assembling operations in the method of assembling the LCD shown in FIG. 5.

Referring first to FIG. 5, an out lead bonding (OLB) process is performed in operation S400.

A driving chip may be attached to the LCD 100 using various methods. For example, a chip on glass (COG) mounting method may be used in which the driving chip is directly attached to a gate region and a data region of the liquid crystal panel 212 without an additional structure. Moreover, a TAB mounting method may be used in which the driving chip is indirectly attached to the gate region and the data region of the liquid crystal panel using a signal connecting member on which the driving chip is mounted. In the present exemplary embodiment of the invention, the TAB mounting method is employed to attach the driving chip to the LCD 100.

The assembling operations will now be described in greater detail. Referring to FIGS. 6 and 7, an anisotropic conductive film (ACF) 272 is disposed on the liquid crystal panel 212 and the gate and data input pads 262 and 264 are formed. Subsequently, after an output side of the TCP is aligned with the gate and data input pads 262 and 264 in which the ACF 272 is disposed, the data and gate TCPs 216 and 218 are attached to the liquid crystal panel 212 using heat and pressure so that the output side of the TCP is bonded to the gate and data input pads 262 and 264. In this case, the ACF 272 is melted by heat and pressure and hardened so that the output side of the TCP and the gate and data input pads 262 and 264 are prevented from being separated from each other and electricity flows through the ACF 272 via conductive particles included in the ACF 272. The conductive particles may be made of, for example, a material selected from the group consisting of silver, nickel, copper, and aluminum. In addition, the ACF 272 may be made of resin having adhesive properties. The width of the ACF 272 may be in a range of about 2 to about 3 mm and the thickness of the ACF 272 may be in a range of about 15 to about 45 micrometers (μm). The ACF 272 can be bonded faster at lower temperatures and pressures.

When the OLB process is completed, a TAB solder process is performed in operation S402.

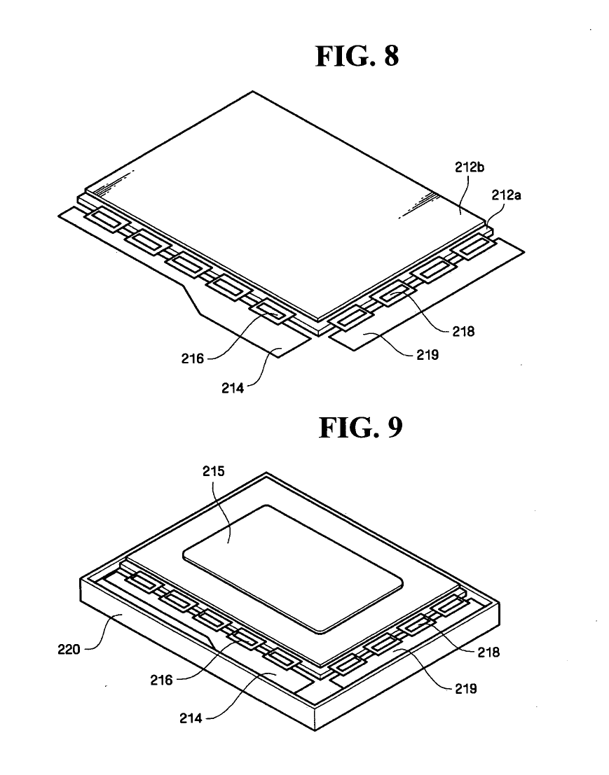

Referring to FIG. 8, an ACF is attached to the output pad of the data and gate PCBs 214 and 219 and then, an input side of the data and gate TCPs 216 and 218 is aligned with the output pad of the data and gate PCBs 214 and 219. The data and gate PCBs 214 and 219 and the data and gate TCPs 216 and 218 are attached to each other using heat and pressure so that the input side of the data and gate TCPs 216 and 218 is attached to the output pad of the data and gate PCBs 214 and 219.

Subsequently, the liquid crystal panel 212 is installed over the mold frame after the TAB solder process in operation S404.

Referring to FIG. 9, when the liquid crystal panel 212 and the data and gate PCBs 214 and 219 are electrically connected to each other by the data and gate TCPs 216 and 218, the liquid crystal panel 212 is installed over the mold frame 230. At this time, to minimize the size of the LCD 100, a predetermined region of the data and gate TCPs 216 and 218 is bent so that the data and gate PCBs 214 and 219 are placed on a bottom surface of the mold frame 230.

Next, the conductive medium 206 is coated on the polarizing film 215 in operation S406.

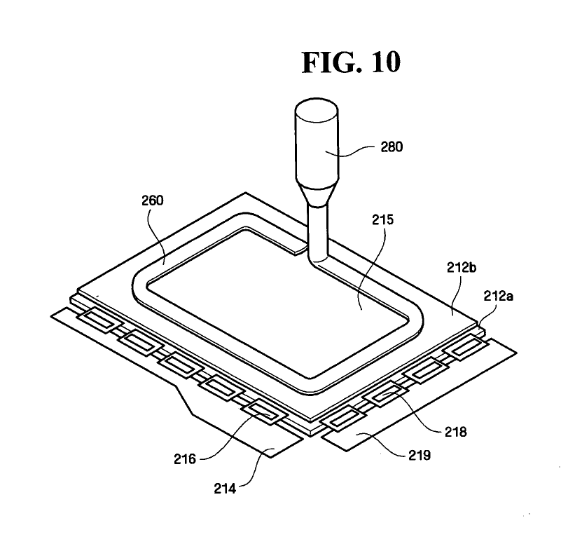

Referring to FIG. 10, the conductive medium 260 is coated using a dispenser 280 so as to surround edges and lateral surfaces of the polarizing film 215 attached to the top surface of the liquid crystal panel 212. Here, the conductive medium 260 is made of, for example, a silicon-based material and has a viscosity in a liquid state. For example, the conductive medium 260 may further include conductive particles, and the conductive particles may be made of a material selected from the group consisting of silver, ceramics, nickel, copper, and aluminum. The conductive medium 260 is formed to have a predetermined height from the top surface of the polarizing film 215 so that it sufficiently contacts the top chassis 240 when attaching the top chassis 240 to the backlight unit 220. Also, the conductive medium 260 is formed to have a predetermined height from the top surface of the liquid crystal panel 212. Thus, the conductive medium 260 may have a height in a range of about 0.20 to about 0.30 mm from the top surface of the polarizing film 215 and a height in a range of about 0.45 to about 0.55 mm from the top surface of the liquid crystal panel 212. In addition, the conductive medium 260 has a width of about 1.2 to about 1.4 mm from the lateral surface of the polarizing film 215, and the conductive medium 260 formed on the polarizing film 215 and the liquid crystal panel 212, have a width of about 1.5 to about 2.5 mm.

Subsequently, a process of hardening the conductive medium 260 is performed in operation S408.

The conductive medium 260 having viscosity in a liquid state can be hardened using a process such as, for example, natural hardening, thermal hardening, and ultraviolet hardening. Here, as in natural hardening, the conductive medium 260 is hardened while reacting to moisture in air, the hardening speed may therefore be determined by, for example, the thickness, temperature, and humidity of the conductive medium 260. As the hardening reaction starts from the surface of the conductive medium 260, when the thickness of the conductive medium 260 increases, the time required for internal hardening of the conductive medium 260 also increases However, if temperature and humidity increase, hardening may be performed rapidly. When, for example, about 20 to about 60 minutes have elapsed at a temperature of about 23° C. and the relative humidity is about 50%, surface hardening starts and when about 15 to about 16 hours have elapsed, full hardening is performed. Thermal hardening is performed for about 30 minutes to about 1 hour at a temperature between about 120° C. and 150° C., and uniformly performed regardless of thickness. Ultraviolet (UV) hardening is performed at room temperature with UV intensity of about 1000 to about 1500 millijoules (MJ) for about 30 to about 60 seconds.

Next, the top chassis 240 and the bottom chassis 250 are connected to each other in operation S410.

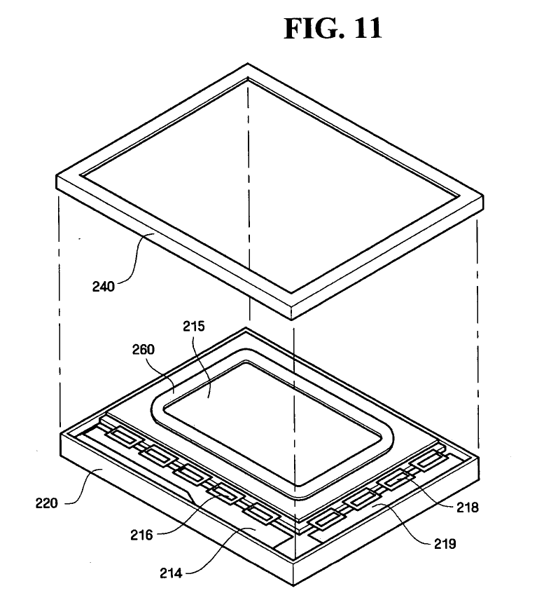

Referring to FIG. 11, to support the data and gate PCBs 214 and 219 and to shield electronic waves generated in the data and gate PCBs 214 and 219, the bottom chassis 250 made of a conductive material is connected to the bottom surface of the mold frame 230. To prevent the liquid crystal panel 212 from being deviated from the mold frame 230, the top chassis 240 is connected to the top surface of the mold frame 230, thereby completing the assembly of the LCD 100.

Subsequently, when the assembly of the LCD 100 is completed, an inspection process is performed so that possible defects in the LCD 100 may be detected in operation S412.

The inspection process may include, for example, aging, final inspection, and appearance inspection. Aging is an inspection process performed at a temperature of about 50° C. and performed for about 2 to about 4 hours by applying a normal driving signal, and line defects, block defects, and driving defects are inspected. Final inspection is performed at room temperature and is used to inspect the function and image quality of the LCD 100 and also to inspect for possible defects in a backlight unit. Appearance inspection is performed at room temperature and includes inspecting for possible screw defects and chassis defects.

As described above, in the liquid crystal display (LCD) and the method of assembling the LCD according to exemplary embodiments of the present invention, a conductive medium is formed so as to surround edges and lateral surfaces of the polarizing film and contacts a portion of a top chassis, so that charges accumulated on the polarizing film may be discharged to the outside of the liquid crystal panel through the top chassis.

In addition, as the conductive medium surrounds the lateral surfaces of the polarizing film, it protects the polarization film from external moisture permeating therein, thereby preventing the polarizing film from shrinking and any accompanying picture abnormality of the LCD panel which may be caused by this shrinkage from occurring.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A liquid crystal display (LCD) comprising:
a liquid crystal panel having a first substrate, a second substrate, and a liquid crystal layer interposed between the first substrate and the second substrate;
a polarizing film formed on at least one surface of the liquid crystal panel; and
a conductive medium formed on at least a part of the polarizing film on the liquid crystal panel.

2. The LCD of claim 1, wherein the conductive medium is formed to surround and seal edges and lateral surfaces of the polarizing film.

3. The LCD of claim 2, further comprising a chassis disposed over the liquid crystal panel so that the chassis contacts at least a portion of the conductive medium.

4. The LCD of claim 2, wherein the conductive medium comprises a silicon-based material and conductive particles.

5. The LCD of claim 4, wherein the conductive particles comprises a material selected from the group consisting of silver, ceramics, nickel, copper, and aluminum.

6. The LCD of claim 1, further comprising a chassis disposed over the liquid crystal panel so that the chassis contacts at least a portion of the conductive medium.

7. The LCD of claim 6, wherein the conductive medium is formed to surround and seal edges and lateral surfaces of the polarizing film.

8. The LCD of claim 6, wherein the conductive medium comprises a silicon-based material and conductive particles.

9. The LCD of claim 8, wherein the conductive particles comprises a material selected from the group consisting of silver, ceramics, nickel, copper, and aluminum.

10. The LCD of claim 1, wherein the conductive medium comprises a silicon-based material and conductive particles.

11. The LCD of claim 10, wherein the conductive particles comprises a material selected from the group consisting of silver, ceramics, nickel, copper, and aluminum.

12. A method of assembling a liquid crystal display (LCD) comprising:
providing a liquid crystal panel having a first substrate and a second substrate formed by interposing a liquid crystal layer on the first substrate;
attaching a polarizing film onto at least one surface of the liquid crystal panel; and
forming a conductive medium on at least a part of the polarizing film on the liquid crystal panel.

13. The method of claim 12, wherein the conductive medium is formed to surround and seal edges and lateral surfaces of the polarizing film.

14. The method of claim 13, further comprising disposing a chassis over the liquid crystal panel so that the chassis contacts at least a portion of the conductive medium.

15. The method of claim 13, wherein the conductive medium comprises a silicon-based material and conductive particles.

16. The method of claim 14, wherein the conductive particles are made of a material selected from the group consisting of silver, ceramics, nickel, copper, and aluminum.

17. The method of claim 12, further comprising disposing a chassis over the liquid crystal panel so that the chassis contacts at least a portion of the conductive medium.

18. The method of claim 17, wherein the conductive medium is formed to surround and seal edges and lateral surfaces of the polarizing film.

19. The method of claim 17, wherein the conductive medium comprises a silicon-based material and conductive particles.

20. The method of claim 18, wherein the conductive particles are made of a material selected from the group consisting of silver, ceramics, nickel, copper, and aluminum.

21. The method of claim 12, further comprising hardening the conductive medium after the sealing of the polarizing film.

22. The method of claim 21, wherein the hardening is performed using a process selected from the group consisting of natural hardening, thermal hardening, and ultraviolet hardening.

23. The method of claim 21, wherein the conductive medium comprises a silicon-based material and conductive particles.

24. The method of claim 23, wherein the conductive particles are made of a material selected from the group consisting of silver, ceramics, nickel, copper, and aluminum.
